(19) United States
(12) Patent Application Publication
(10) Pub. No.: US 2026/0054495 A1
(43) Pub. Date: Feb. 26, 2026

(54) DEGASSING DEVICE AND INKJET RECORDING APPARATUS

(71) Applicant: KYOCERA Document Solutions Inc., Osaka (JP)

(72) Inventors: Hideki ISHIDA, Osaka-shi (JP); Takeru YOSHIDA, Osaka-shi (JP); Hiroaki WATANABE, Osaka-shi (JP); Takeshi WATANABE, Osaka-shi (JP)

(73) Assignee: KYOCERA Document Solutions Inc., Osaka (JP)

(21) Appl. No.: 18/810,321

(22) Filed: Aug. 20, 2024

(51) Int. Cl. B41J 2/19; B41J 2/175; B41J 2/18

(52) U.S. Cl. CPC B41J 2/19; B41J 2/17596; B41J 2/18; B41J 2202/07

(57) ABSTRACT

A degassing device removes air dissolved in liquid under a pressure decreased atmosphere. The degassing device includes a liquid tank, a pressure decreasing device, a circulation flow pass, a circulation device, and a floating body. The liquid tank stores the liquid. The pressure decreasing device decreases pressure in the liquid tank. The circulation flow pass communicates different positions of the liquid tank. The circulation device circulates the liquid through the circulation flow pass. The floating body floats on a liquid surface in the liquid tank. An inlet port from the circulation flow pass to the liquid tank is provided above the liquid surface. The liquid flowing in through the inlet port into the liquid tank falls on the floating body above the liquid surface.

### BACKGROUND

The present disclosure relates to a degassing device and an inkjet recording apparatus.

In an inkjet recording apparatus, when an amount of dissolved gas of ink increases, bubbles may be generated inside a recording head, causing an ejection failure. Therefore, a technique for decreasing an amount of the dissolved gas in the ink has been studied. For example, there has been proposed a configuration in which a pressure inside an ink tank is decreased to degas the ink.

In the above-described configuration, in order to suppress re-dissolution of the air into the ink in the ink tank, a floating body is floated on the liquid surface. However, in the configuration, because the surface area is narrowed owing to the floating body, a degassing efficiency is lowered.

### SUMMARY

A degassing device according to the present disclosure removes air dissolved in liquid under a pressure decreased atmosphere. The degassing device includes a liquid tank, a pressure decreasing device, a circulation flow pass, a circulation device, and a floating body. The liquid tank stores the liquid. The pressure decreasing device decreases pressure in the liquid tank. The circulation flow pass communicates different positions of the liquid tank. The circulation device circulates the liquid through the circulation flow pass. The floating body floats on a liquid surface in the liquid tank. An inlet port from the circulation flow pass to the liquid tank is provided above the liquid surface. The liquid flowing in through the inlet port into the liquid tank falls on the floating body above the liquid surface.

An inkjet recording apparatus according to the present disclosure includes the degassing device, and a recording head which ejects the liquid degassed by the degassing device, to a sheet.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view showing an inkjet recording apparatus according to one embodiment of the present disclosure.

FIG. 2 is a schematic view showing an ink supply configuration according to the embodiment of the present disclosure.

FIG. 3 is a schematic view showing a circulation pump according to the embodiment of the present disclosure.

FIG. 4 is a sectional view schematically showing a degassing device according to the embodiment of the present disclosure.

FIG. 5 is a sectional view schematically showing the degassing device according to the embodiment of the present disclosure.

FIG. 6 is a graph showing a result of a circulation degassing according to the embodiment.

FIG. 7 is a graph showing a result in which the ink is left after the circulation degassing according to the embodiment is performed.

FIG. 8 is a sectional view showing the degassing device according to a first modified example of the embodiment of the present disclosure.

FIG. 9 is a sectional view showing the degassing device according to a second modified example of the embodiment of the present disclosure.

FIG. 10 is a sectional view showing the degassing device according to a third modified example of the embodiment of the present disclosure.

FIG. 11 is a plan view showing a floating body according to the third modified example of the embodiment of the present disclosure.

FIG. 12 is a sectional view taken along the line I-I in FIG. 11.

FIG. 13 is a perspective view showing the floating body according to the third modified example of the embodiment of the present disclosure.

FIG. 14 is a plan view showing the floating body according to the third modified example of the embodiment of the present disclosure.

FIG. 15 is a sectional view taken along the line II-II in FIG. 14.

FIG. 16 is a perspective view showing the floating body according to the third modified example of the embodiment of the present disclosure.

FIG. 17 is a sectional view showing the degassing device according to a fourth modified example of the embodiment of the present disclosure.

FIG. 18 is a sectional view showing the degassing device according to a fourth modified example of the embodiment of the present disclosure.

FIG. 19 is a sectional view taken along the line III-III in FIG. 17.

FIG. 20 is a sectional view showing the degassing device according to a sixth modified example of the embodiment of the present disclosure.

FIG. 21 is a sectional view showing the degassing device according to the sixth modified example of the embodiment of the present disclosure.

FIG. 22 is a perspective view showing an inclined flow pass according to the sixth modified example of the embodiment of the present disclosure.

FIG. 23 is a plan view showing the inclined flow pass according to the sixth modified example of the embodiment of the present disclosure.

### DETAILED DESCRIPTION

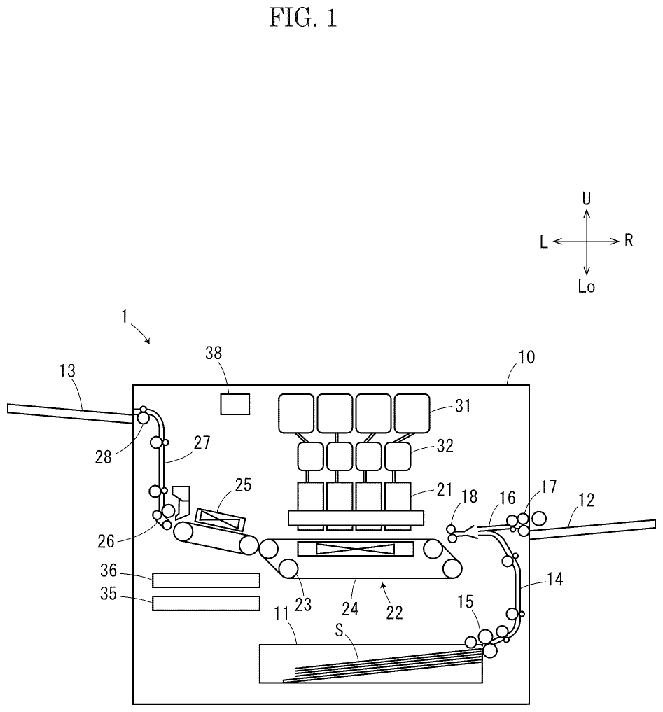

Hereinafter, with reference to the drawings, an inkjet recording apparatus 1 of the present embodiment will be described. FIG. 1 is a schematic view showing the inkjet recording apparatus 1 according to the present embodiment. For convenience of explanation, the front side of the paper surface on which FIG. 1 is drawn is defined as the front side of the inkjet recording apparatus 1, and the left-and-right direction will be described with reference to the direction in which the inkjet recording apparatus 1 is viewed from the front side. The arrows L, R, U, and Lo attached to each figure indicate the left, right, upper, and lower sides of the inkjet recording apparatus 1, respectively.

An inkjet recording apparatus 1 ejects ink from each inkjet recording head 21 toward a sheet S as a recording medium and performs printing. The inkjet recording apparatus 1 includes a box-shaped housing 10 in which various kinds of device are housed. In the lower portion of the housing 10, a sheet feeding cassette 11 in which the sheet S is set is housed, and a manual sheet feeding tray 12 on which the sheet S is set by hand is installed on the right side surface of the housing 10. On the upper portion of the left side surface of the housing 10, a sheet discharge tray 13 on which the recorded sheet S is stacked is installed.

In the right side portion in the housing 10, a first conveyance path 14 along which the sheet S is conveyed from the sheet feeding cassette 11 to the recording head 21 provided in the center of the housing 10 is formed. On the upstream side of the first conveyance path 14, a first sheet feeding part 15 which feeds the sheet S from the sheet bundle in the sheet feeding cassette 11 is provided, and a registration roller 18 which adjusts the feeding timing of the sheet S is provided in the downstream portion of the first conveyance path 14. Further, a sheet feeding path 16 of the manual sheet feeding tray 12 is merged with the downstream portion of the first conveyance path 14, and a second sheet feeding part 17 which feeds the sheet S from the sheet bundle on the manual sheet feeding tray 12 is provided on the sheet feeding path 16.

On the downstream side of the registration roller 18, a conveying device 22 and the recording head 21 provided for each color (for example, black, cyan, magenta, and yellow) are installed. The registration roller 18 corrects the skew of the sheet S and then sends the sheet S to the conveying device 22 in accordance with the ink ejecting operation by each recording head 21. In the housing 10, an ink container 31 and an ink tank 32 for each recording head 21 are provided. The ink of each ink container 31 is temporarily stored in the ink tank 32, the ink is degassed as necessary, and then the ink is supplied from the ink tank 32 to the recording head 21.

The conveying device 22 is constituted by winding a conveyance belt 24 around a plurality of tension rollers 23 installed below the recording heads 21. On the downstream side of the conveying device 22, a drying device 25 which dries the ink of the sheet S is provided. On the downstream side of the drying device 25, a decurl device 26 which corrects the curl generated on the sheet S by drying the ink is provided. On the downstream side of the decurl device 26, a second conveyance path 27 along which the sheet S is conveyed toward the sheet discharge tray 13 is formed. In the downstream portion of the second conveyance path 27, a sheet discharge part 28 which discharges the recorded sheet S to the sheet discharge tray 13 is provided.

Below the drying device 25, a maintenance unit 35 which cleans the recording heads 21 and a cap unit 36 which caps the recording heads 21 are provided. The maintenance unit 35 is provided with a squeegee-shaped wiping blade, and the wiping blade scrapes the ink remaining on the nozzle surface of the recording head 21. The cap unit 36 is provided with a head cap, and the nozzle surface of the recording head 21 is capped with the head cap. The head cap suppresses drying of the ink in the nozzle. The drying of the ink in the nozzle may be further suppressed by storing a liquid such as a cleaning liquid in the head cap.

Further, the inkjet recording apparatus 1 is provided with a control device 38 for controlling the entire apparatus. The control device 38 may be composed of a processor or a logic circuit (hardware) formed in an integrated circuit or the like. In the case of a processor, the processor reads and executes a program stored in a memory, and various processes are executed. For example, a CPU (Central Processing Unit) is used as the processor. The memory is constituted by one or more storage devices such as a ROM (Read Only Memory), a RAM (Random Access Memory) or the like depending on the application.

At the time of image recording, the sheet S is fed from the sheet feeding cassette 11 and the manual sheet feeding tray 12 by the first sheet feeding part 15 and the second she in whiteet feeding part 17, respectively, and then sent to the registration roller 18. In accordance with the ejecting timing of the ink, the sheet S is conveyed from the registration roller 18 to the conveyance belt 24, the degassed ink is ejected from each recording head 21, and a color image is recorded on the surface of the sheet S. The sheet S is dried by the drying device 25, and the curl of the sheet S is corrected by the decurl device 26. The sheet S is conveyed to the sheet discharge part 28 through the second conveyance path 27, and the recorded sheet S is discharged to the sheet discharge tray 13 by the sheet discharge part 28.

By the way, the liquid surface of the ink touches the air in the ink tank 32, and the dissolving of the air proceeds, and the nozzle of the recording head 21 may be clogged by bubbles in the ink. Therefore, it is desired to appropriately keep an amount of dissolved gas in the ink. For example, a method has been proposed in which by passing the ink through the hollow fiver filter in a state where the pressure of the circumference of the hollow fiber filter is decreased, the air is moved from the wall surface of the hollow fiber to the pressure decreased side to degas the ink. This method requires the expensive hollow fiber filter and requires periodic replacement operations, which increase cost.

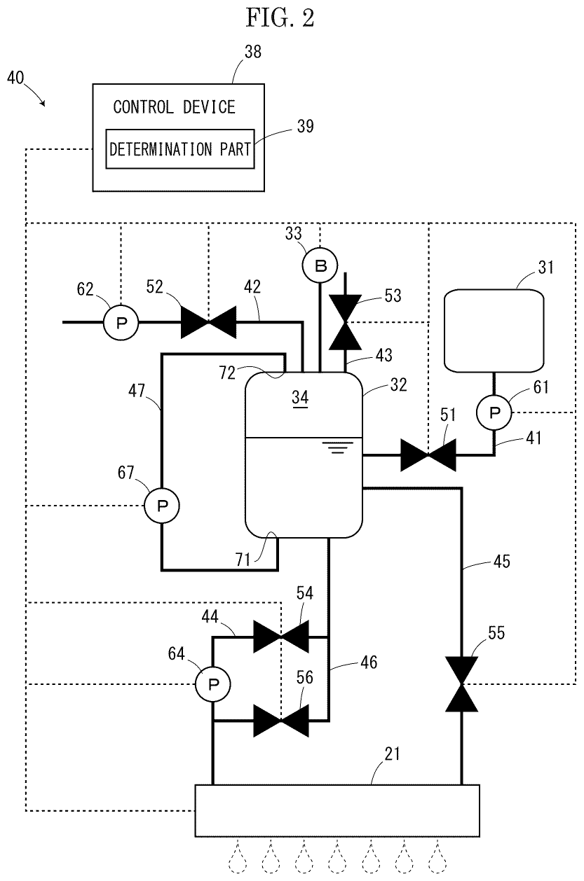

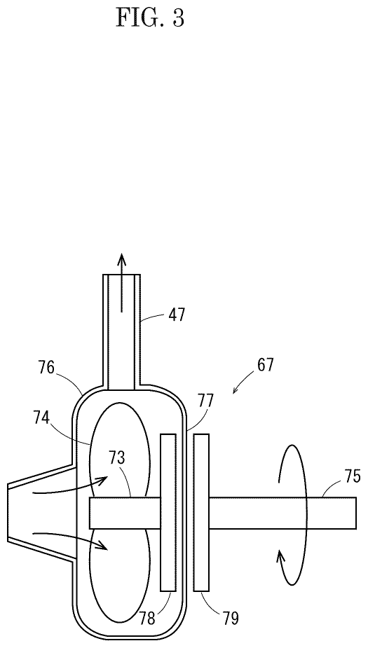

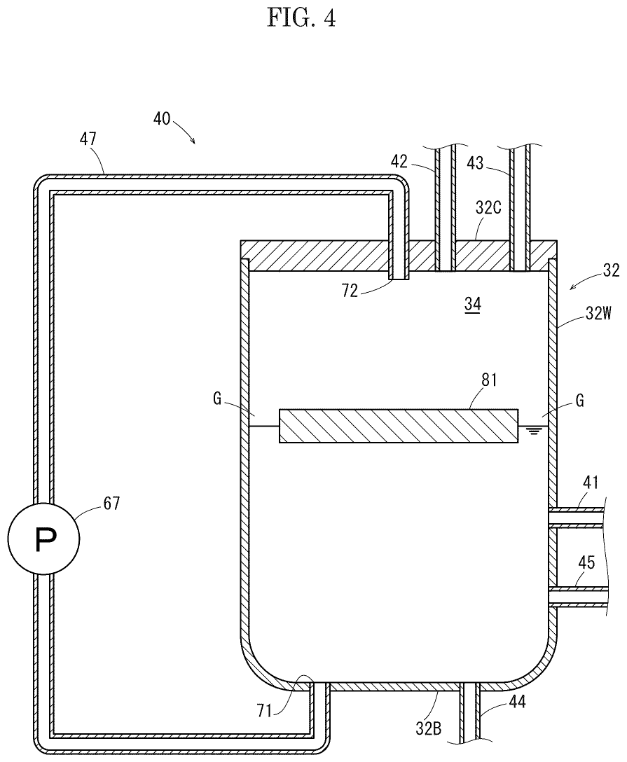

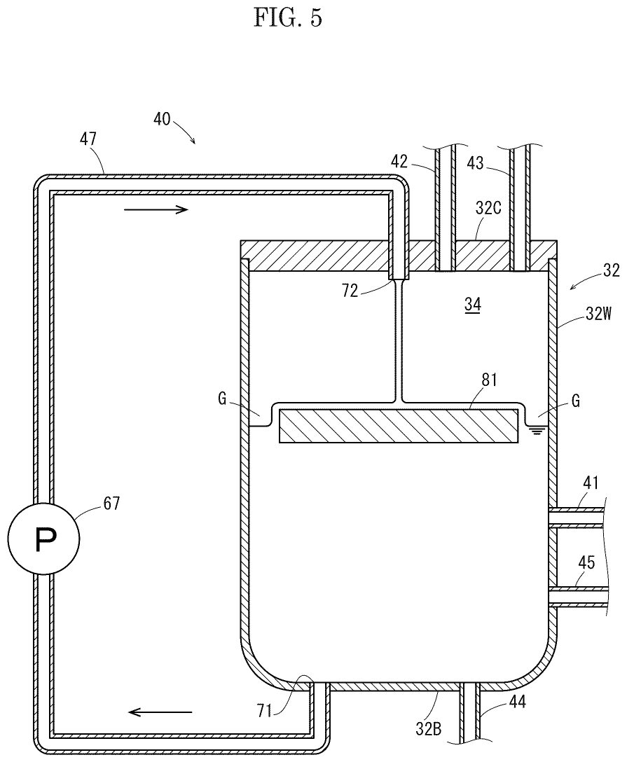

In order to prevent the clogging of the nozzle, a method (hereinafter referred to as the stirring degassing method) has been proposed in which the ink is stirred by the stirrer in a state in which the pressure in the ink tank 32 is decreased below an atmospheric pressure to degas the ink. In the stirring degassing method, a magnetic force is externally applied to the stirrer in the ink tank 32, and the stirrer is rotated by the magnetic force to stir the ink in the ink tank 32. When the depth of the ink and the tank diameter are large, the ink is difficult to be stirred, and the degassing efficiency is lowered. As the rotational speed of the stirrer is increased, the stirring becomes easier, but when the rotational speed of the stirrer becomes too high, a detuning phenomenon occurs and the rotational sound of the stirrer becomes large. Therefore, in the present embodiment, a circulation degassing method shown below is adopted.

[Degassing Device] A degassing device 40 according to this embodiment will be described. FIG. 2 is a schematic diagram showing an ink supply configuration according to the present embodiment. FIG. 3 is a schematic view showing a circulation pump 67 according to the present embodiment. FIG. 4 and FIG. 5 are sectional views schematically showing the degassing device 40. Although the inkjet recording apparatus 1 according to the present embodiment is provided with the ink supply configuration for each color of the ink, one ink supply configuration will be described here because these ink supply configurations have the same structure.

[Ink Tank] The ink tank 32 has a cylindrical side wall portion 32W whose axial direction is along the upper-and-lower direction, a bottom portion 32B for closing the lower end portion of the side wall portion 32W, and a lid body portion 32C for closing the upper end portion of the side wall portion 32W. The horizontal cross section of the inner surface of the side wall portion 32W is preferably circular. Preferably, the side wall portion 32W and the bottom portion 32B are integrally formed.

[Replenishment Flow Pass] A replenishment flow pass 41 communicates with the ink container 31 and the ink tank 32. One end portion of the replenishment flow pass 41 is connected to the side wall portion 32W of the ink tank 32 below the liquid surface. On the replenishment flow pass 41, a replenishment pump 61 and a replenishment valve 51 are provided.

[Air Release Flow Pass] An air release flow pass 43 is connected to the lid body portion 32C, and communicates with the upper space 34 of the ink tank 32. On the air release flow pass 43, an air release valve 53 is provided.

[Pressure Decreasing Flow Pass] A pressure decreasing flow pass 42 is connected to the lid body portion 32C, and communicates with the upper space 34 of the ink tank 32. On the pressure decreasing flow pass 42, a pressure decreasing pump 62 and a pressure decreasing valve 52 are provided.

[Supply Flow Pass] A supply flow pass 44 communicates with the ink tank 32 and the recording head 21. One end portion of the supply flow pass 44 is connected to the bottom portion 32B of the ink tank 32. On the supply flow pass 44, a supply valve 54 and a supply pump 64 are provided.

[Recovery Flow Pass] A recovery flow pass 45 communicates with the ink tank 32 and the recording head 21. On the recovery flow pass 45, a recovery valve 55 is provided.

[Bypass Flow Pass] The supply flow pass 44 includes a bypass flow pass 46 bypassing the supply valve 54 and the supply pump 64. On the bypass flow pass 46, a bypass valve 56 is provided.

[Circulation Flow Pass] A circulation flow pass communicates with the vicinity of the bottom surface of the ink of the ink tank 32 and the vicinity of the liquid surface. The circulation flow pass 47 has an outlet port 71 through which the ink flows out from the ink tank 32 into the circulation flow pass 47, and an inlet port 72 through which the ink flows in from the circulation flow pass 47 into the ink tank 32. The outlet port 71 is connected to the bottom portion 32B of the ink tank 32, and the inlet port 72 is connected to a center portion of the lid body portion 32C. That is, the inlet port 72 is positioned higher than the outlet port 71. On the circulation flow pass 47, a circulation pump 67 is provided. The ink is circulated via the circulation flow pass 47 by the circulation pump 67.

[Circulation Pump] Since the inside of the ink tank 32 is in a pressure decreased state during the degassing operation, a reciprocation pump such as a diaphragm type pump is easily affected by the decreased pressure. Therefore, it is preferable that the circulation pump 67 uses a pump that pumps the ink by a rotating body. For example, as the circulation pump 67, a non-positive displacement pump such as a centrifugal pump, an oblique flow pump, and an axial flow pump, or a positive displacement rotary pump such as a vane pump, a gear pump, and a screw pump may be used. By using these pumps, unlike the reciprocation pump, the influence of pressure decreasing in the ink tank 32 can be suppressed to circulate the ink.

In general, the recording head 21 may be included in the circulation flow pass 47 of the circulation degassing method, but in the present embodiment, the recording head 21 is not included in the circulation flow pass 47. That is, the circulation flow pass 47 is provided separately from the pass for supplying the ink to the recording head 21. Since the recording head 21 is not included in the circulation flow pass 47, the possibility that the meniscus formed in the nozzle of the recording head 21 is broken and the outside air enters the recording head 21 can be reduced.

As shown in FIG. 3, a pump shaft 73 of the circulation pump 67 and a motor shaft 75 are disposed on both sides of a partition wall 77 so that power can be transmitted without contact. A pump casing 76 is formed in the middle of the circulation flow pass 47, and the pump shaft 73 attached with an impeller 74 is housed in the pump casing 76. A motor (not shown) is provided outside the circulation flow pass 47. Discs 78 and 79 are provided at the end portions of the pump shaft 73 and the motor shaft 75, and the discs 78 and 79 face each other across the partition wall 77 of the pump casing 76. Magnets (not shown) in which the S and N poles are alternately arranged in the circumferential direction are provided on opposite surfaces of the discs 78 and 79.

The pump shaft 73 and the motor shaft 75 are magnetically coupled (magnet coupling), and the power is transmitted from the motor shaft 75 to the pump shaft 73 using the magnetic force. The impeller 74 in the pump casing 76 can be rotated without penetrating the motor shaft 75 through the pump casing 76 while the pump casing 76 is kept in a liquid-tightly sealed state. Since the space between the discs 78 and 79 of the pump shaft 73 and the motor shaft 75 is partitioned by the partition wall 77 of the pump casing 76, even if a pressure difference between the inside and the outside of the pump casing 76 occurs when the pressure of the ink tank 32 is decreased, the ink leakage caused by the pressure difference is surely prevented.

The replenishment pump 61, the pressure decreasing pump 62, the supply pump 64, the circulation pump 67, the replenishment valve 51, the pressure decreasing valve 52, the air release valve 53, the supply valve 54, the recovery valve 55, and the bypass valve 56 are controlled by the control device 38. The control device 38 includes a determination part 39 which determines the necessity of the degassing operation in accordance with a leaving time of the ink. When the determination part 39 determines that degassing of the ink is unnecessary, the degassing operation is not performed. Even if the air is dissolved again by leaving the ink, the ink can be used without the degassing within the allowable time.

[Barometer] The ink tank 32 is provided with a barometer 33 which measures an atmospheric pressure in the upper space 34 of the ink tank 32. The control device 38 acquires atmospheric pressure data from the barometer 33.

Next, the basic operation of the degassing device 40 will be described. Here, the standby state will be described as an initial state.

[Standby State] In the standby state, the replenishment valve 51, the pressure decreasing valve 52, and the supply valve 54 are closed, and the air release valve 53, the recovery valve 55, and the bypass valve 56 are opened. The ink is stored in the ink tank 32, the liquid surface touches the air in the upper space 34 opened to the atmosphere, and then the air is dissolved in the ink with the lapse of time.

In the standby state, the determination part 39 of the control device 38 determines whether the degassing is necessary. For example, the control device 38 is provided with a timer, and the leaving time of the ink is measured by the timer. An amount of dissolved gas of the ink can be estimated from one or more parameters such as an atmospheric pressure, a temperature of the ink, and an elapsed time from the last printing. Therefore, the determination part 39 stores conversion information indicating a correspondence relationship between each parameter and the amount of dissolved gas of the ink, and estimates the amount of dissolved gas of the ink based on each parameter. In addition, the determination part 39 stores conversion information indicating a correspondence relationship between the amount of dissolved gas of the ink and the allowable time, and the allowable time is set based on the amount of dissolved gas of the ink. The allowable time is a time during which the printing is allowed without degassing even if the ink is left. For the conversion information indicating the correspondence relationship between each parameter and the amount of dissolved gas of the ink and the conversion information indicating the correspondence relationship between the amount of dissolved gas of the ink and the allowable time, map data, a lookup table, a conversion equation, and the like are used. These map data, lookup table, and conversion equation are obtained experimentally, empirically, and theoretically in advance.

When the leaving time of the ink is within the allowable time, the determination part 39 determines that the degassing is unnecessary because an oxygen saturation degree is low. When the leaving time of the ink exceeds the allowable time, the determination part 39 determines that the degassing is necessary because the oxygen saturation degree is high. If the degassing is necessary, the control device 38 performs the pressure decreasing process and the degassing process described below.

[Pressure Decreasing Process] In the pressure decreasing process, the control device 38 closes the replenishment valve 51, the air release valve 53, the supply valve 54, the recovery valve 55, and the bypass valve 56, opens the pressure decreasing valve 52, and drives the pressure decreasing pump 62. Then, the air is sucked out from the upper space 34 of the ink tank 32, and the upper space 34 is decreased in pressure. The control device 38 stops the pressure decreasing pump 62 when the atmospheric pressure in the upper space 34 indicated by the barometer 33 reaches a target value (for example, −50 [kPa]).

[Degassing Process] When the pressure decreasing process is completed, the control device 38 performs the degassing process. In the degassing process, the control device 38 closes the replenishment valve 51, the pressure decreasing valve 52, the air release valve 53, the supply valve 54, the recovery valve 55, and the bypass valve 56, and drives the circulation pump 67 for a predetermined period. When the circulation pump 67 is driven, the ink in the ink tank 32 circulates through the circulation flow pass 47. The ink near the bottom surface of the ink tank 32 having a large amount of dissolved air flows out into the circulation flow pass 47 through the outlet port 71, and the ink in the circulation flow pass 47 flows into the vicinity of the liquid surface in the ink tank 32 through the inlet port 72. The liquid surface of the ink is exposed to the pressure decreased atmosphere to remove the air dissolved in the ink near the liquid surface. By smoothly replacing the ink near the liquid surface having a small amount of dissolved air with the ink near the bottom surface having a large amount of dissolved air, the degassing efficiency is improved. In addition, unlike the stirring degassing method, the depth of the ink and the tank diameter are not affected, and the driving sound of the circulation pump 67 is suppressed rather than the rotating sound of the stirrer, and the quietness is enhanced.

[Head Circulation Process] The head circulation process may be performed before or after the degassing process and may be performed at a unique timing. In the head circulation process, the control device 38 closes the replenishment valve 51, the pressure decreasing valve 52, and the bypass valve 56, opens the air release valve 53, the supply valve 54, and the recovery valve 55, and drives the supply pump 64. Then, the ink is supplied from the ink tank 32 to the recording head 21 through the supply flow pass 44, and the ink is recovered from the recording head 21 to the ink tank 32 through the recovery flow pass 45. By circulating the ink between the recording head 21 and the ink tank 32, the ink with increased viscosity is replaced in the recording head 21 and bubbles are removed from the recording head 21.

[Print Process] In the printing operation by the recording head 21, the replenishment valve 51, the pressure decreasing valve 52 and the supply valve 54 are closed, and the air release valve 53, the recovery valve 55, and the bypass valve 56 are opened. That is, at the printing operation, the ink tank 32 is released to atmospheric pressure. During the printing operation, the ink tank 32 is not decreased in pressure such that substantial degassing occurs. Every time when the ink is ejected from the recording head 21, the ink is supplied from the ink tank 32 to the recording head 21 through the bypass flow pass 46 and the recovery flow pass 45. In some cases, the ink is replenished in the middle of the ink replacement operation, the printing operation, and the like. During the ink replenishment operation, the replenishment valve 51 is opened and the replenishment pump 61 is driven. The ink is replenished from the ink container 31 to the ink tank 32 through the replenishment flow pass 41 by driving the replenishment pump 61.

FIG. 1 and the others are schematically drawn, and the recording head 21 is actually disposed above the ink tank 32. A negative pressure is applied to the ink in the recording head 21 by a head difference from the ink in the ink tank 32, and a meniscus is formed in the nozzle of the recording head 21 by the negative pressure. After the ink is ejected from the recording head 21, the surface tension of the ink acts to reduce the surface area of the meniscus, and the resulting negative pressure draws the reduced amount of the ink from the ink tank 32 into the recording head 21. The recovery valve 55 may be closed to supply the ink to the recording head 21 only from the bypass flow pass 46.

If the ink tank 32 is decreased in pressure to the extent that substantial degassing occurs in a state where the recording head 21 and the ink tank 32 are connected, the meniscus in the nozzle may be destroyed. Even if the meniscus is not destroyed, there is a risk that the shape of the meniscus in the nozzle changes from that when the ink tank 32 is released to the atmosphere, and the ejection characteristics of the ink may be changed. In the present embodiment, since the ink tank 32 is not decreased in pressure so as to cause the substantial degassing during the printing operation, the meniscus in the nozzle of the recording head 21 is not destroyed, and the shape is not changed and the ejection characteristic is not changed.

Next, the features of this embodiment will be described in detail. The degassing device 40 according to the present embodiment removes the air dissolved in the liquid (for example, the ink) under a pressure decreased atmosphere, and includes the liquid tank (for example, the ink tank 32), a pressure decreasing device (for example, the pressure decreasing pump 62), the circulation flow pass 47, a circulation device (for example, the circulation pump 67), and a floating body 81. The liquid tank stores the liquid. The pressure decreasing device decreases the pressure of the inside of the liquid tank. The circulation flow pass communicates different positions of the liquid tank. The circulation device circulates the liquid through the circulation flow pass. The floating body 81 floats on the liquid surface in the liquid tank. The inlet port 72 from the circulation flow pass 47 to the liquid tank is provided above the liquid surface, and the liquid flowing into the liquid tank from the inlet port 72 falls on the floating body 81 above the liquid surface. Specifically, they are as follows. Since the ink tank 32, the pressure decreasing pump 62, the circulation flow pass 47, and the circulation pump 67 are as described above, the floating body 81 will be mainly described below.

[Floating Body] The floating body 81 is made of material having a unit volume mass smaller than that of the ink, such as polypropylene. The floating body 81 is formed in a plate shape of a size smaller than the horizontal cross-section of the inner surface of the side wall portion 32W. In this embodiment, since the horizontal cross-section of the inner surface of the side wall portion 32W is circular, the floating body 81 is also formed in a circular plate shape. The outer diameter of the floating body 81 is smaller than the inner diameter of the side wall portion 32W. Therefore, a gap G is formed between the inner surface of the side wall portion 32W of the ink tank 32 and the outer edge of the floating body 81, and contact between the floating body 81 and the side wall portion 32W is reduced.

In the standby state, the pressure decreasing process, the head circulation process and the printing process (see FIG. 4), the liquid is exposed to the air only at the liquid surface in the gap G, so that the re-dissolution of the air is suppressed.

On the other hand, in the degassing process, the ink is circulated through the circulation flow pass 47 (see FIG. 5). The ink falls from the inlet port 72 on the upper surface of the floating body 81 to form a layer of the ink covering the upper surface of the floating body 81, and then falls from the outer edge of the floating body 81 to the liquid surface. If the inlet port 72 is provided below the liquid surface, the ink is exposed to the air only at the liquid surface in the gap G, but in this embodiment, the ink continues to be exposed to the air until it falls from the inlet port 72 to the liquid surface in the gap G via the upper surface of the floating body 81, thereby improving the degassing efficiency.

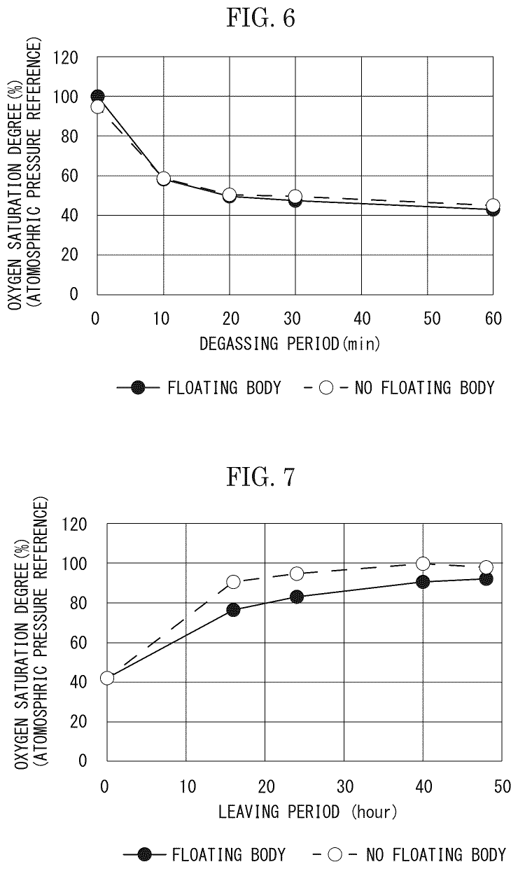

FIG. 5 shows a state in which the posture of the floating body 81 is kept horizontal and the ink spreads unevenly over the entire upper surface of the floating body 81. In practice, it is considered that the floating body 81 is inclined to causes a bias in the flow of the ink on the upper surface of the floating body 81. However, compared with the case where the inlet port 72 is provided below the liquid surface, the area where the ink is exposed to the air becomes larger, so that the degassing efficiency is improved.

[Experiment] FIG. 6 is a graph showing the results of the circulation degassing. The viscosity of the ink is 7 [mPa·s], the temperature of the ink is 25 [°C], the tank diameter of the ink tank 32 is 60 [mm], the depth of the ink is 28 [mm], and the circulation flow rate of the ink is 770 [ml/min]. The change in oxygen saturation degree with time is compared between the case where the floating body 81 is provided and the case where the floating body 81 is not provided. The vertical axis shows the oxygen saturation degree [%], and the horizontal axis shows the degassing period [min]. According to the graph, it can be seen that the oxygen saturation degree is changed in the same manner between the cases. This means that the lowering of the degassing efficiency caused by the floating body 81 is suppressed.

FIG. 7 is a graph showing the result of leaving the ink after the end of circulation degassing. The vertical axis shows the oxygen saturation degree [%], and the horizontal axis shows the leaving period [hour] after the end of circulation degassing. According to the graph, it can be seen that the increase in oxygen saturation degree is suppressed in the case where the floating body 81 is provided than in the case where the floating body 81 is not provided. This means that the re-dissolution of the air is suppressed by the floating body 81.

According to the degassing device 40 according to the present embodiment described above, the degassing device 40 according to the present embodiment removes the air dissolved in the liquid (for example, the ink) under a pressure decreased atmosphere, and includes the liquid tank (for example, the ink tank 32), the pressure decreasing device (for example, the pressure decreasing pump 62), the circulation flow pass 47, the circulation device (for example, the circulation pump 67), and the floating body 81. The liquid tank stores the liquid. The pressure decreasing device decreases the pressure of the inside of the liquid tank. The circulation flow pass communicates different positions of the liquid tank. The circulation device circulates the liquid through the circulation flow pass. The floating body 81 floats on the liquid surface in the liquid tank. The inlet port 72 from the circulation flow pass 47 to the liquid tank is provided above the liquid surface, and the liquid flowing into the liquid tank from the inlet port 72 falls on the floating body 81 above the liquid surface. According to this configuration, the re-dissolution of the air can be suppressed without lowering the degassing efficiency.

The inkjet recording apparatus 1 according to the present embodiment is provided with the degassing device 40 and the recording head 21 which ejects the liquid degassed by the degassing device 40 to the sheet S. According to this configuration, the deterioration of image quality caused by the generation of bubbles can be suppressed.

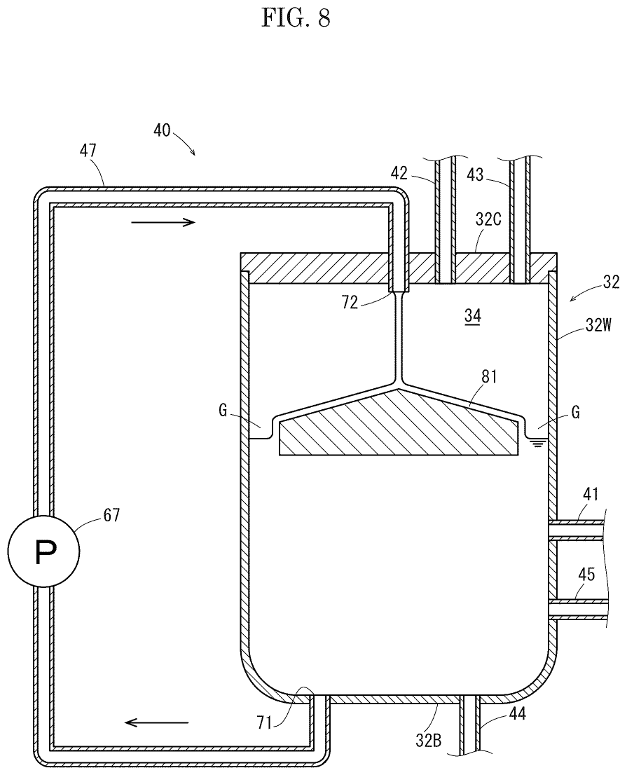

The above embodiment may be modified as follows.

[First Modified Example] FIG. 8 is a cross-sectional view showing the degassing device 40 according to the first modified example. In this modified example, the upper surface of the floating body 81 is formed into a conical surface of a circular cone. The inlet port 72 is provided above the apex of the conical surface which is the upper surface of the circular cone. When the ink is circulated, the ink flowing in from the inlet port 72 falls on the upper surface of the floating body 81 and flows down along the upper surface of the floating body 81. FIG. 8 shows a state in which the ink falls on the apex of the upper surface of the floating body 81 and spreads unevenly over the entire upper surface. In practice, it is considered that the ink falls on a position off the apex of the upper surface due to inclination of the floating body 81 or horizontal movement of the floating body 81, thereby causing a bias in the flow of the ink. However, the degassing efficiency is improved because the area where the ink is exposed to the air becomes larger than the case where the inlet port 72 is provided below the liquid surface.

Further, in the above embodiment, since the upper surface of the floating body 81 is not inclined, when the circulation of the ink is stopped, it needs a long time for the ink to flow down from the upper surface of the floating body 81 to the liquid surface, and there is a risk that the re-dissolution of the air is promoted. In addition, when the upper surface of the floating body 81 is not inclined, the ink tends to remain on the upper surface. Since the remaining ink does not contribute to the decrease of the amount of dissolved air of the ink stored in the ink tank 32, the degassing efficiency is lowered. On the other hand, in the present modified example, when the circulation of the ink is stopped, the ink quickly flows down from the upper surface of the floating body 81 to the liquid surface, and the ink hardly remains on the upper surface, so that the re-dissolution of the air can be suppressed without lowering the degassing efficiency.

Even if the upper surface of the floating body 81 is formed into a conical surface of a square cone, the same effect as in the first modified example can be obtained. In short, the upper surface of the floating body 81 may be form into a conical surface.

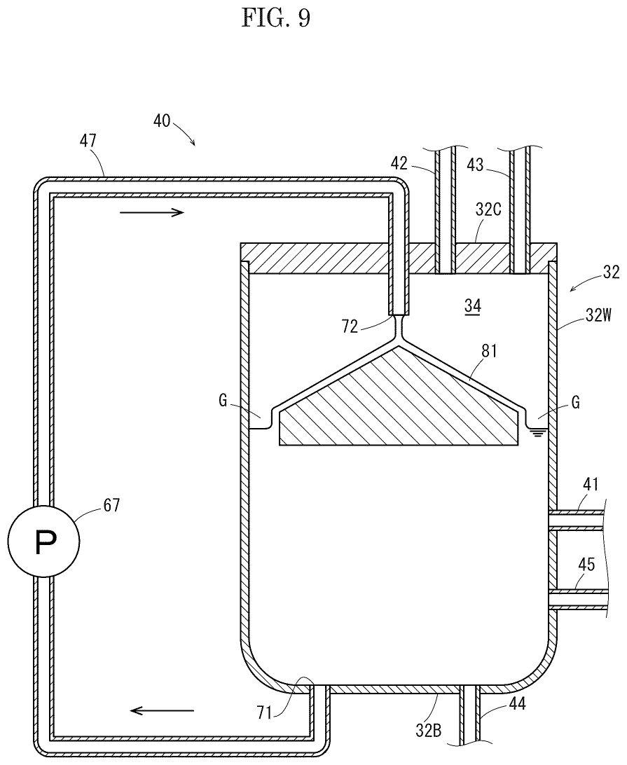

In addition, the upper surface of the floating body 81 may be at least inclined. Since the upper surface of the floating body 81 is inclined, the effect similar to that of the first modified example can be obtained. However, when the upper surface of the floating body 81 is inclined in one direction, the ink may flow down intensively from the lower side of the upper surface to a specific portion on the liquid surface, and the circulation of the ink may be interrupted at a portion than the specific portion. On the other hand, in the present modified example, the deviation of the ink flow can be suppressed.

[Second Modified Example] FIG. 9 is a cross-sectional view showing the degassing device 40 according to the second modified example. In this modified example, the distance between the inlet port 72 and the floating body 81 is set such that the liquid falling on the floating body 81 does not scatter. Specifically, the inclination angle of the upper surface of the floating body 81 is larger and the position of the inlet port 72 is lower than those of the first modified example. Therefore, the distance from the inlet port 72 to the upper surface of the floating body 81 is shorter than that in the first modified example.

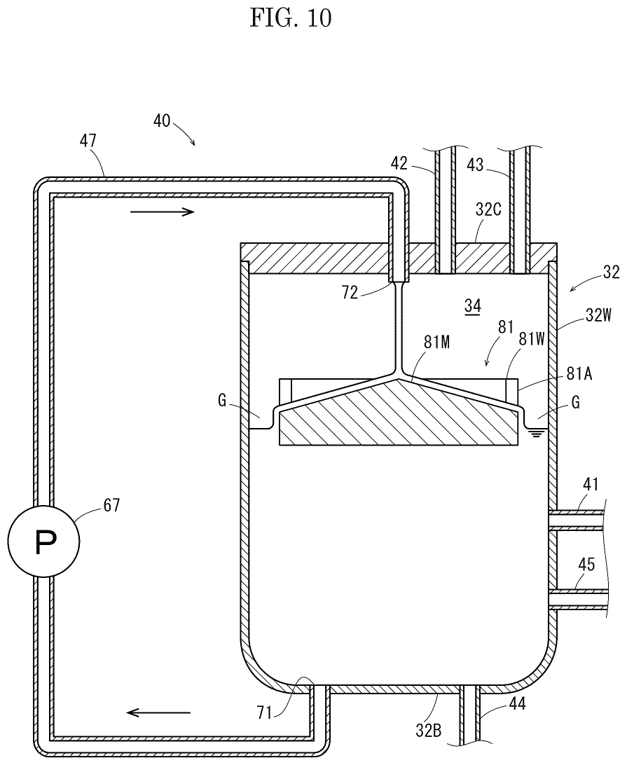

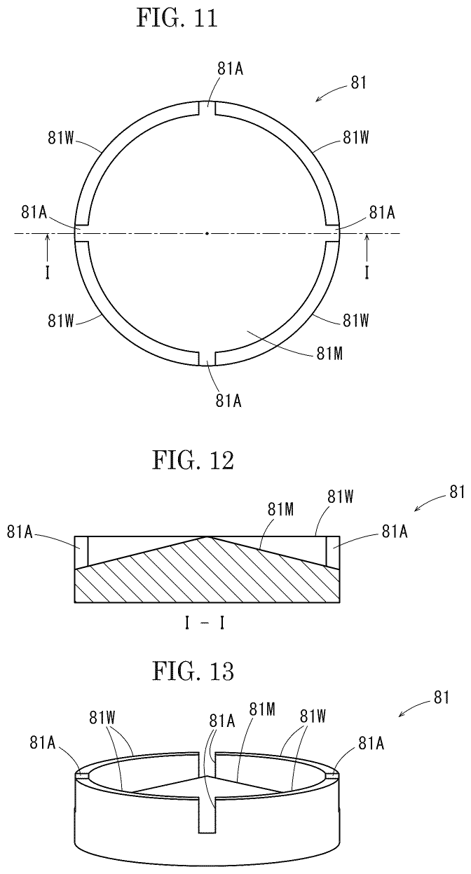

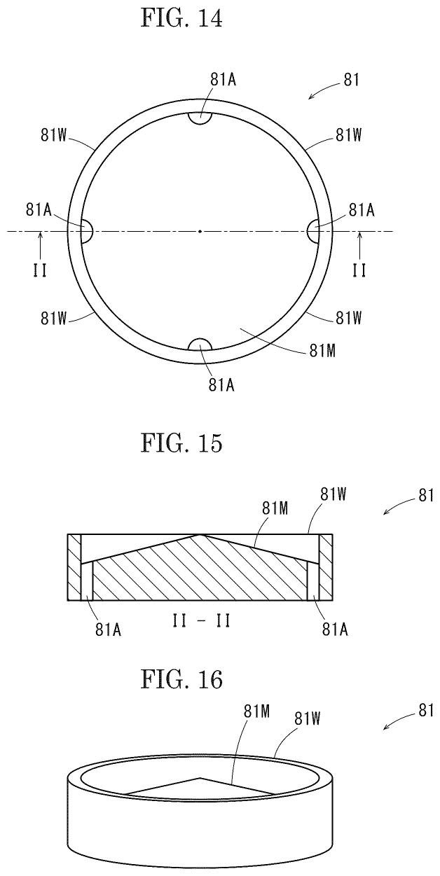

When the ink is scattered, the ink droplets adhere to the wall surface of the ink tank 32. The droplets are easy to be degassed because of their small volume, but they are likely to stay on the wall without falling onto the liquid surface. Since the droplets stayed on the wall surface do not contribute to the decreasing of an amount of the dissolved air of the ink stored in the ink tank 32, the degassing efficiency is lowered. On the other hand, in the present modified example, since the ink fallen on the floating body 81 is hardly scattered, it is possible to suppress the lowering of the degassing efficiency. The fact that the upper surface of the floating body 81 is inclined also has an effect of suppressing the scattering of the ink.

[Third Modified Example] FIG. 10 is a cross-sectional view showing the degassing device 40 according to the third modified example. FIG. 11 is a plan view showing the floating body 81 according to the third modified example. FIG. 12 is a sectional view taken along the line I-I of FIG. 11. FIG. 13 is a perspective view showing the floating body 81 according to the third modified example. FIG. 14 is a plan view showing the floating body 81 according to the third modified example. FIG. 15 is a sectional view taken along the line II-II of FIG. 14. FIG. 16 is a perspective view showing the floating body 81 according to the third modified example.

In this modified example, the floating body 81 has a wall part 81W which blocks the flow of ink, and an opening 81A through which the ink blocked by the wall part 81W is discharged. Specifically, the floating body 81 has a body portion 81M similar to the floating body 81 according to the first modified example. The wall part 81W stands upright around the edge of the upper surface of the main body portion 81M. The wall part 81W has a circular shape along the edge of the upper surface of the main body portion 81M when viewed from above. The height of the upper end portion of the wall part 81W is substantially equal to the height of the apex of the upper surface of the body portion 81M.

FIG. 11 to FIG. 13 show an example in which the opening 81A is provided in the wall part 81W. The opening 81A passes through the wall part 81W. The opening 81A may be provided in at least one position, but preferably in a plurality of positions in the circumferential direction (in this modified example, four positions) at equal intervals.

On the other hand, FIG. 14 to FIG. 16 show an example in which the opening 81A is provided in the main body portion 81M. The opening 81A penetrates the main body portion 81M in the upper-and-lower direction at the boundary between the upper surface of the main body portion 81M and the inner surface of the wall part 81W. The opening 81A may be provided in at least one position, but preferably in a plurality of positions in the circumferential direction (in this modified example, four positions) at equal intervals.

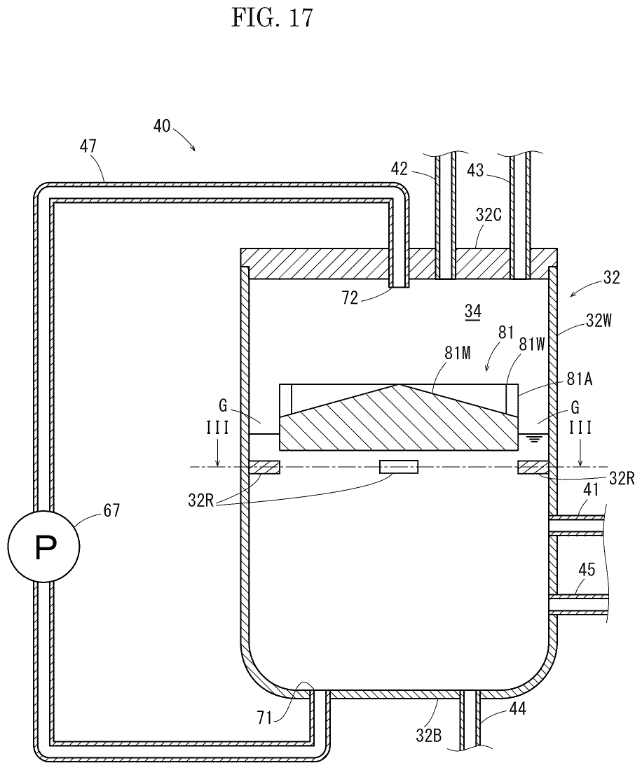

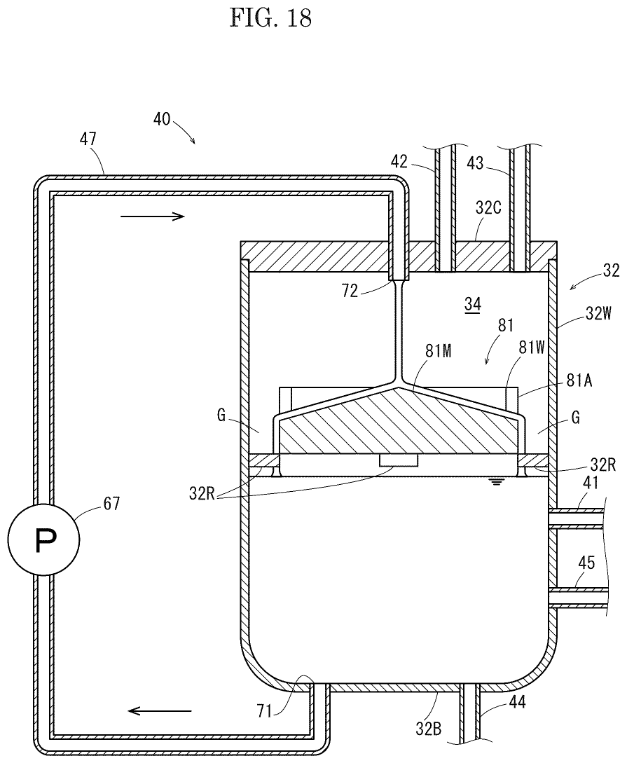

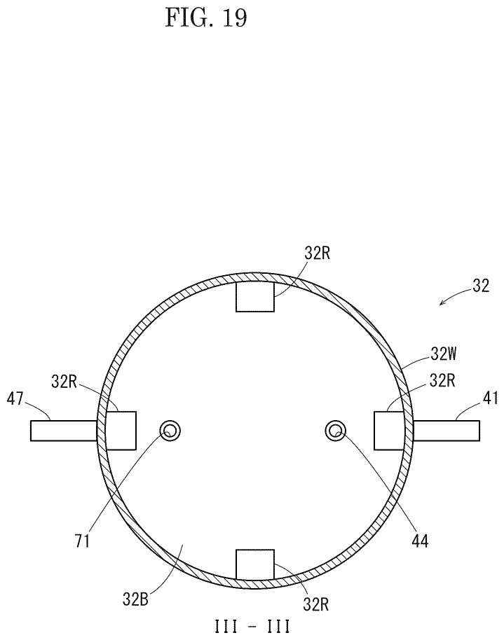

According to this modified example, since the time for the ink to remain on the upper surface of the floating body 81 is longer than the case where the wall part 81W is not provided, the degassing efficiency can be improved. When an amount of the flowing ink is large, a part of the ink may be blocked, resulting in an ink pool in which the ink is temporarily stayed. When the ink pool occurs, the surface area of the ink may be reduced at the ink pool as a result. However, in the ink pool, the ink flow in various directions including the upper-and-lower direction occurs, and the ink on the surface is replaced, so that an amount of the ink exposed to the decreased pressure atmosphere increases, and the degassing efficiency can be improved. When the circulation of the ink is stopped, the ink blocked by the wall part 81W is discharged from the opening 81A, so that the re-dissolution of the air can be suppressed.

[Fourth Modified Example] FIG. 17 and FIG. 18 are cross-sectional views showing the degassing device 40 according to the fourth modified example. FIG. 19 is a cross-sectional view taken along the line III-III of FIG. 17. In this modified example, the ink tank 32 includes a regulation part 32R which regulates the lowering of the floating body 81 when the liquid surface is lowered by the circulation of the ink. Specifically, the regulation part 32R protrudes from the inner surface of the side wall portion 32W of the ink tank 32. The regulation part 32R is provided at a plurality of positions (in this modified example, four positions) in the circumferential direction of the side wall portion 32W at equal intervals (see FIG. 19).

When the circulation pump 67 does not circulate the ink (see FIG. 17), the liquid surface is positioned above the regulation part 32R, and the floating body 81 floats on the liquid surface. When the circulation pump 67 circulates the ink (see FIG. 18), a part of the ink is moved on the pass from the inlet port 72 to the liquid surface via the upper surface of the floating body 81, so that the liquid surface is lowered below the regulation part 32R and the floating body 81 runs on the regulation part 32R. In this case, a space is formed between the liquid surface and the lower surface of the floating body 81. The ink is exposed to air in the process of flowing down on the upper surface of the floating body 81, and is also exposed to air at the liquid surface located below the floating body 81. Therefore, according to the present modified example, the degassing efficiency can be improved compared with the case where the regulation part 32R is not provided.

[Fifth Modified Example] In the above embodiment, at least a part of the floating body 81 may sink below the liquid surface due to being pushed by the ink falling from the inlet port 72 to the floating body 81. Whether the floating body 81 is dipped depends on various conditions such as the mass of the floating body 81, the specific gravity between the floating body 81 and the ink, and the inflow amount per unit time of the ink flowing in from the inlet port 72, and the others. When a part of the floating body 81 sinks, the liquid surface spreads above the floating body 81, so that the degassing efficiency is improved. When the whole of the floating body 81 sinks, the liquid surface spreads over the entire area of the floating body 81, so that the same degassing efficiency as in the above embodiment can be obtained.

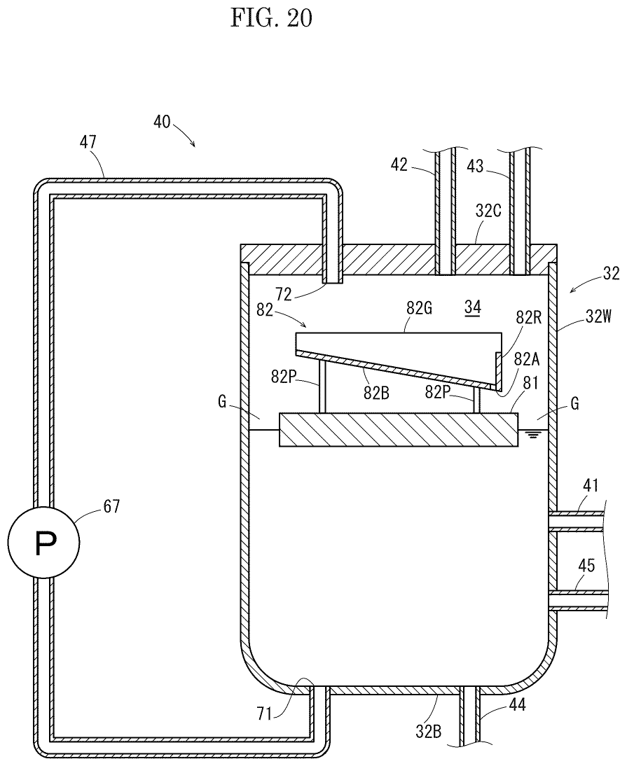

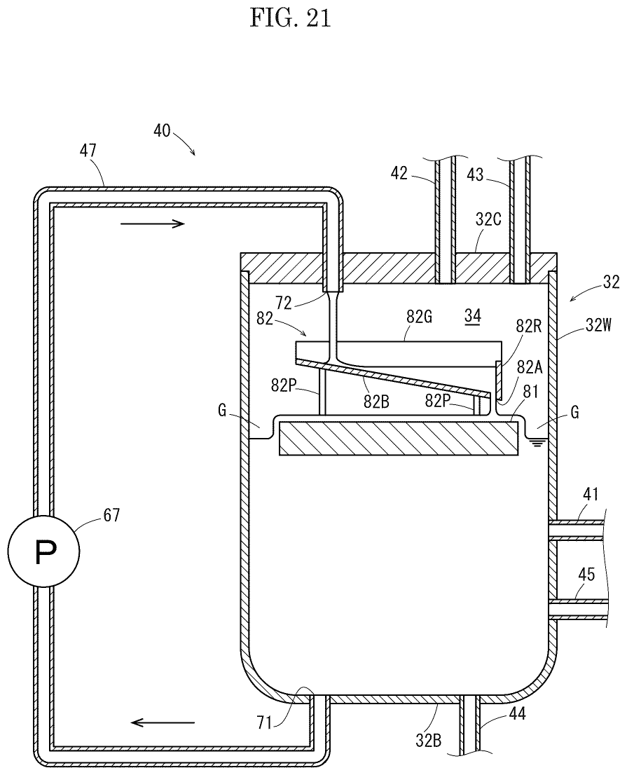

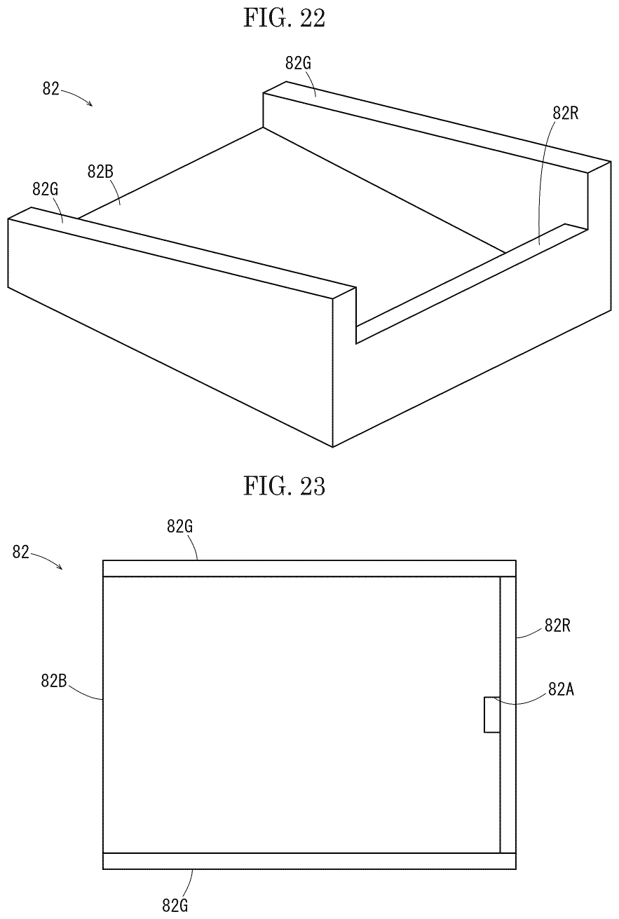

It should be noted that, basically, the ink falling portion of the floating body 81 remains above the liquid surface even when the ink continues to fall on the portion. However, the ink falling portion of the floating body 81 may be below the liquid surface in the state where the ink continues to fall on the portion. Even when it is below the liquid surface, the falling ink fall on the floating body 81, hardly falls from the liquid surface to a deep position, and tends to stay near the liquid surface, thereby improving the degassing efficiency. In addition, if the height of the floating body 81 is to be kept at a high level even when receiving the falling ink, it is necessary to reduce the weight such as making the inside of the floating body 81 hollow, which may easily cause breakage or increase the manufacturing cost. However, the sinking of the floating body 81 is allowable so that a possibility for using the solid floating body 81 can be heightened.

[Sixth Modified Example] FIG. 20 and FIG. 21 are cross-sectional views showing the degassing device 40 according to the sixth modified example. FIG. 22 is a perspective view showing an inclined flow pass 82 according to the sixth modified.

The degassing device 40 according to the modified example is provided with an inclined flow pass 82 supported by the floating body 81 via a gap, and the ink flowing into the ink tank 32 from the circulation flow pass 47 flows down to the upper surface of the floating body 81 via the inclined flow pass 82. Specifically, the inclined flow pass 82 has a bottom part 82B, a guide wall part 82G, and a regulation wall part 82R. The bottom part 82B is rectangular, and inclined in one direction. A pair of the guide wall parts 82G facing each other are provided along the inclined direction of the bottom part 82B. The guide wall part 82G guides the ink flow, and the ink flow does not flow in a direction other than the inclined direction. The regulation wall part 82R is provided on the lower side of the bottom part 82B to block the flow of the ink. An opening 82A penetrates the bottom part 82B in the upper-and-lower direction at the boundary between the regulation wall part 82R and the bottom part 82B. A plurality of posts 92P are provided on the upper surface of the floating body 81. The inclined flow pass 82 is supported by the posts 82P.

When the circulation pump 67 does not circulate the ink (see FIG. 20), the floating body 81 floats on the liquid surface. In this case, since the liquid is exposed to the air only at the liquid surface in the gap G, the re-dissolution of the air is suppressed. On the other hand, when the circulation pump 67 circulates the ink (see FIG. 21), the ink flows along the inclined flow pass 82 after falling from the inlet port 72 to the inclined flow pass 82, falls from the opening 82A to the floating body 81, and flows down from the upper surface of the floating body 81 to the liquid surface, so that the area where the ink is exposed to the air increases compared with the case where the inclined flow pass 82 is not provided, thereby improving the degassing efficiency.

[Additional Modified Example] In the above embodiment, the inlet port 72 is connected to the center portion of the lid body portion 32C. However, the inlet port 72 may be connected to the side wall portion 32W of the ink tank 32 above the liquid level, so that the ink flows in the lateral direction from the inlet port 72 and falls on the upper surface of the floating body 81.

In the above embodiment, an example in which the degassing device 40 is provided in the inkjet recording apparatus 1 is shown, but the degassing device 40 can also be applied to devices used in other fields such as semiconductor manufacturing fields and display manufacturing fields. That is, it can be applied to degassing of chemical solutions, electrolytic solutions, liquid resins, adhesives, solvents, lubricating oils, liquid foods, serum, or the like, other than the ink.

In the above embodiment, an example in which the pressure decreasing pump 62 is used as a pressure decreasing device is shown, but the pressure decreasing device may be a device capable of reducing pressure in the ink tank 32, and for example, the pressure decreasing device may be an ejector.

In the above embodiment, an example in which the circulation pump 67 is used as a circulation device is shown, but the circulation device may be a device capable of circulating the ink through the circulation flow pass 47, and for example, the circulation device may be an ejector.

1. A degassing device which removes air dissolved in liquid under a pressure decreased atmosphere, the degassing device comprising:
a liquid tank in which the liquid is stored;
a pressure decreasing device which decreases pressure in the liquid tank;
a circulation flow pass which communicates different positions of the liquid tank;
a circulation device which circulates the liquid through the circulation flow pass; and
a floating body floating on a liquid surface in the liquid tank, wherein
an inlet port from the circulation flow pass to the liquid tank is provided above the liquid surface, and
the liquid flowing in through the inlet port into the liquid tank falls on the floating body above the liquid surface.

2. The degassing device according to claim 1, wherein,
an upper surface of the floating body is inclined.

3. The degassing device according to claim 1, wherein,
the upper surface of the floating body is formed into a conical surface.

4. The degassing device according to claim 1, wherein
a distance between the inlet port and the floating body is set such that the liquid falling on the floating body is not scattered.

5. The degassing device according to claim 1, wherein
the floating body has a wall portion which blocks a flow of the liquid.

6. The degassing device according to claim 5, wherein
the floating body has an opening portion through which the liquid blocked by the wall portion is discharged.

7. The degassing device according to claim 1, wherein
the liquid tank includes a regulation part which regulates a lowering of the floating body when the liquid surface is lowered by circulation of the liquid.

8. The degassing device according to claim 1, wherein
at least a part of the floating body sinks below the liquid surface by being pushed with the liquid falling on the floating body through the inlet port.

9. The degassing device according to claim 1, comprising:
an inclined flow pass supported by the floating body and having a gap from the floating body, wherein
the liquid flowing into the liquid tank from the circulation flow pass falls down on the upper surface of the floating body through the inclined flow pass.

10. An inkjet recording apparatus comprising:
the degassing device according to claim 1, and
a recording head which ejects the liquid degassed by the degassing device, to a sheet.
